(19) United States
(12) Patent Application Publication
(10) Pub. No.: US 2017/0213201 A1
(43) Pub. Date: Jul. 27, 2017

(54) System and method for controlling and managing shopping trolleys

(71) Applicants: José Antonio QUINTERO TRAVERSO, Puerto Real (ES); Enrique Alfonso QUINTERO TRAVERSO, Puerto Real (ES); José Manuel REINA RODRÍGUEZ, Puerto Real (ES)

(72) Inventors: José Antonio QUINTERO TRAVERSO, Puerto Real (ES); Enrique Alfonso QUINTERO TRAVERSO, Puerto Real (ES); José Manuel REINA RODRÍGUEZ, Puerto Real (ES)

(21) Appl. No.: 15/302,012

(22) PCT Filed: Apr. 7, 2015
(86) PCT No.: PCT/ES2015/070275

§ 371 Date: Oct. 5, 2016

(30) Foreign Application Priority Data
Apr. 9, 2014 (ES) 201430531

(51) Int. Cl. G06Q 20/20; H02J 7/35; H04N 7/18; G07F 17/00; H04W 64/00; H04W 40/24

(52) U.S. Cl. CPC G06Q 20/208; H04W 64/006; H04W 40/244; H04N 7/18; G07F 17/0057; H02J 7/35; G06K 7/10762

(57) ABSTRACT

System (1) and method for controlling and managing shopping trolleys (2), wherein the system comprises an ID terminal (3) for each trolley (2) to be controlled, said terminal being equipped with means for communicating with at least one trolley parking bay unit (4), at least one location-finding system (6), and at least one unit (5) for detecting the passage of the trolley through the checkout. The method comprises a method for combined control of trolley output implemented in the ID terminal and the parking bay unit, a method for locating the trolley demarcation, a method for combined control of passage of the trolley through the checkout implemented in the ID terminal and the unit for detecting the passage of the trolley through the checkout, and a method for combined control of trolley input implemented in the ID terminal and the trolley parking bay unit.

### OBJECT OF THE INVENTION

The present invention relates to a system and a method for controlling and managing shopping trolleys, applicable to corporate trolleys, that is, those that belong to an entity, typically a commercial entity, offering them to their customers to transport purchases.

### BACKGROUND OF THE INVENTION

It is of interest to track customers' purchasing routines in shops and malls in order to learn their habits and adapt offers to them. These trackings are currently made based on the information recorded in the cash registers in sales made, or by personal surveys.

Information on sales records provides data of operations executed, but not of potential operations. Effectively, it is recorded that the customer has purchased certain articles, but there is no information about others articles by which he/she could find interesting but have not purchased, especially less-everyday articles and with higher cost. To obtain these data, personal surveys would mainly serve, but surveys are performed in a limited universe since, for obvious reasons, the surveys cannot be performed for all customers of the supermarket or mall.

On the other hand, virtually all commercial entities have trolleys or shopping carts where customers can bring their purchases from points of sale to their vehicles. These trolleys have other uses, and so are frequent source of thefts. Thus, over the years, anti-theft devices of a mechanical nature have been implemented, where each trolley implements an attachment box, with a chain terminated as a key that is inserted into the rear trolley box, then allowing the release of a coin that has been previously introduced in order to be able to release the trolley.

Trolleys are parked in one or more parkings or corrals for trolleys, hooked with one another through their attachment boxes. To take one of them, the corresponding coin is entered into the attachment box, and when the trolley is left, the key from previous trolley is entered, or the initial of trolley parking, to retrieve the coin, leaving the trolley coupled to the rest.

These mechanical systems have the problem of being easily releasable with a rounded tool, so they do not fulfil their intended function. Also, they do not complement their functions with other benefits of control of passage of the trolley through the checkout, such as time control, so it is necessary to provide more trolleys. Nor do they provide identification through an image of the user who takes each trolley, or information about the revenue generated by the use of trolley.

### DESCRIPTION OF THE INVENTION

The system for controlling and managing shopping trolleys solves the technical problems raised, since it allows on the one hand tracking the particular route made by each trolley in the shop or commercial area, and therefore provides information about the sales areas more frequently visited by customers, regardless of purchases. Therefore, the system of the invention has a first function of providing data about the preferred areas visited by users. It also adds the trolley identification when checking-out, and means for identifying the articles purchased, so the data can be processed later associating the route followed by the trolley and the items purchased.

A further advantage of the system of invention is that the control carried out serves to minimize the trolley thefts.

According to the invention, the system comprises the provision of an identification (ID) terminal for each trolley to be controlled, including an electronic module which is capable of carrying a particular ID for each trolley. This ID terminal is ideally programmable in situ, so the inventive ID terminal may include at least one electronic programmer of the trolley IDs.

The ID terminal, in addition, is equipped with means for communicating with at least one trolley parking bay unit, at least one location-finding system of trolleys based on reception of a signal, and at least one unit for detecting the passage of the trolley through the checkout.

Communications are embodied through any wireless communication, preferably through radiofrequency modules (RF) and/or infrared (IR) and/or through network connection, and thus each of the trolleys that are part of the total may be identified, as well as to monitor a route that it has followed for a period of time, such as the time-of-day when it was acquired, the pathway taken, and the time-of-day that it was returned back in the trolley parking, providing enough data to determine the use thereof. Detecting also its passage through the check-out and tracking of the location in the commercial marketplace. For this location, in addition to the wireless links and/or IR, the invention accommodates gathering of images through a closed-circuit television (CCTV).

In this way, the system of the invention enables combining all the information collected by the trolley from its extraction until its return to the trolley parking, including the passage through check-out with revenue information contributed by the trolley user, providing enough data that can be statistically processed to commercial optimization, not forming part said subsequent process of the invention. Also it serves as a control means to avoid or decrease the theft of trolleys, due to the deterrence provided by the detection that a trolley is no longer in the scope of the commercial store or marketplace.

The operation of the system includes a method that is part of the invention, since it produces technical effects that are part of the solution to the technical problems raised. This method includes:

A method for combined control of trolley output implemented in the ID terminal and the parking bay unit; a method for locating the trolley demarcation; a method for combined control of passage of the trolley through the checkout implemented in the ID terminal and the unit for detecting the passage of the trolley through the checkout; and a method for combined control of trolley input implemented in the ID terminal and the trolley parking bay unit; these methods implementing the steps described in the preferred embodiment of the invention.

### DESCRIPTION OF DRAWINGS

FIG. 1—Is a schematic view of the system of the invention.

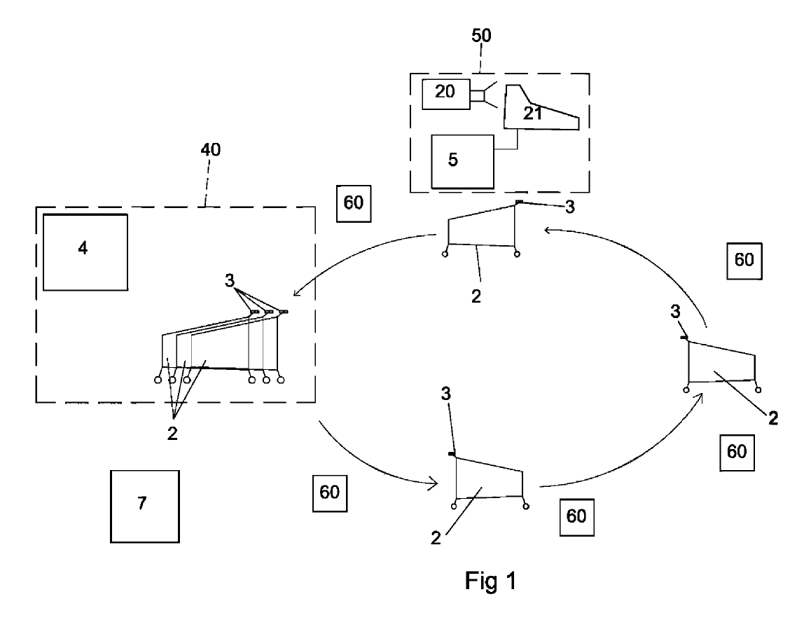

FIG. 2—Is a block diagram of the ID terminal arranged in each trolley to be controlled.

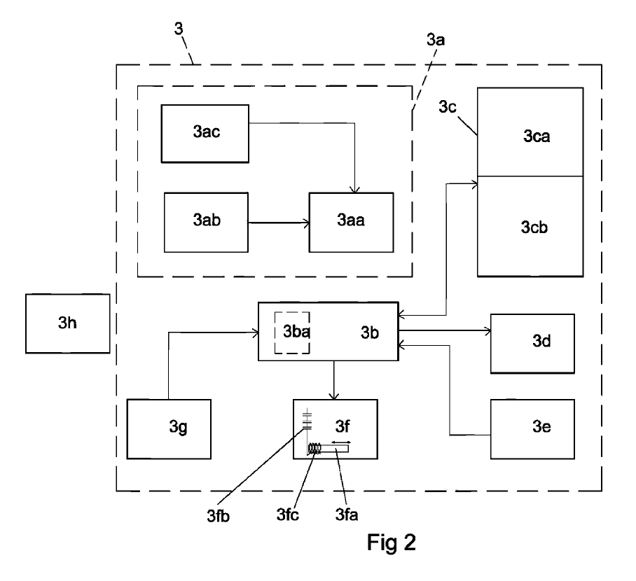

FIG. 3—Is a block diagram of the trolley parking bay unit.

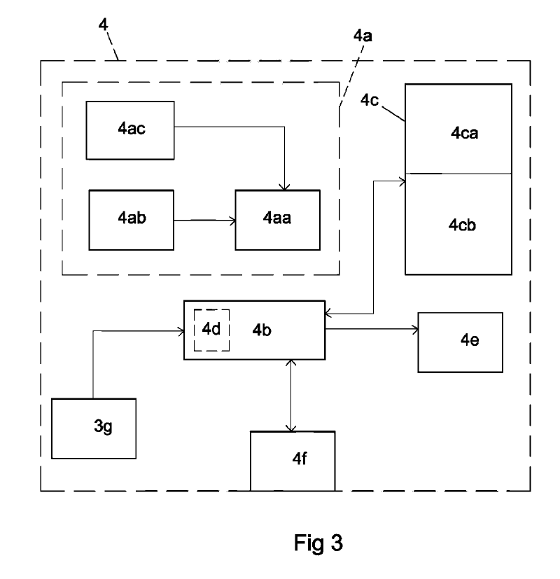

FIG. 4—Is a block diagram of the unit for detecting the passage of the trolley through the checkout.

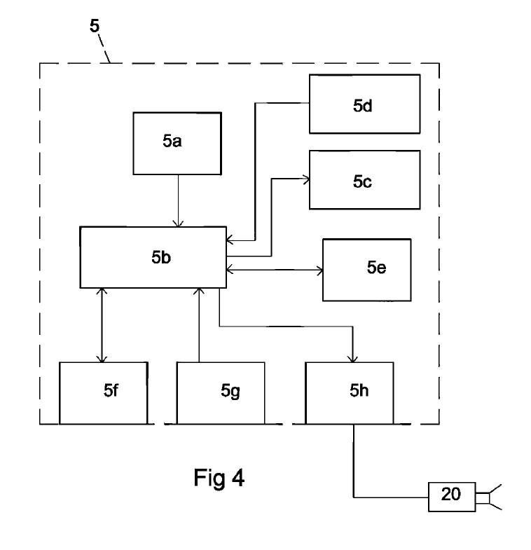

FIG. 5—Is a block diagram of an electronic programmer of the ID of each trolley.

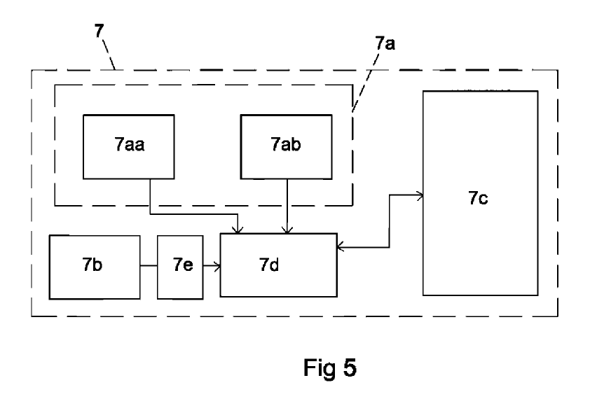

FIG. 6—Is a block diagram of the location-finding system.

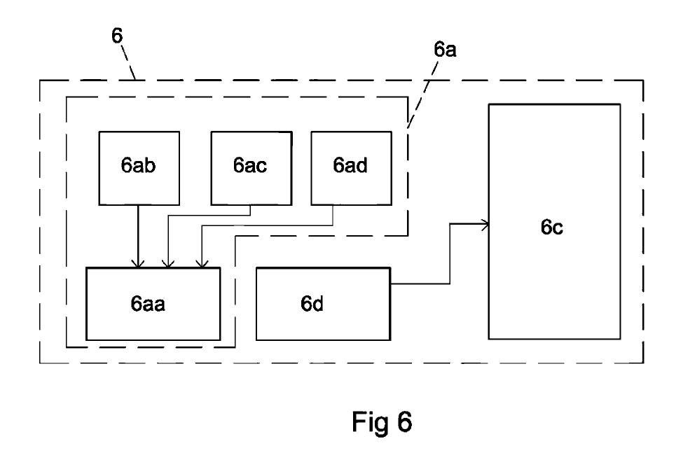

### PREFERRED EMBODIMENT OF THE INVENTION

The system (1) for controlling and managing shopping carts or trolleys (2) is applied to corporate trolleys, understood as those that belong to an entity, typically a commercial shopping store that offers the trolleys to its customers to transport purchases.

According to the invention, the system comprises an ID module (3) for each trolley (2) to be controlled, said terminal being equipped with means for communicating with at least one trolley parking bay unit (4), located in this example in the trolley parking itself (40), at least one location-finding system (6) of trolleys based on the reception of a signal and at least one unit (5) for detecting the passage of the trolley through the checkout, also located in the vicinity of the cash register (50). Communications are ideally embodied through wireless means, preferably through links of RF modules (radio frequency) and infrared IR, and/or network connection in the way that is described below.

ID terminal (3) of each trolley (2) comprises a first power supply (3a), a first embedded system (3b) with memory (3ba) for storing data and the programming of the particular ID—which identifies each trolley—, a first wireless communication module (3c), preferably RF, comprised of emitter (3ca) and receiver (3cb), at least one IR emitter (3d), a coin introduction detector (3e), a coin lock (3f), a key detector (3g), and optionally a barcode reader (3h), while the first power supply (3a) comprises a first switched-mode power supply (3aa) which will power the devices when they need it, and comprising a first rechargeable battery (3ab), typically made of lithium ion or lithium polymer, and a first photovoltaic unit (3ac) such that the photovoltaic unit (3ac) cooperates in recharging the rechargeable battery (3ab). The use of a switched-mode power supply, i.e., based on switched converters, will extend the life of the first rechargeable battery (3ab). The barcode reader (3h) can be integrated in the ID terminal (3) or external and connectable to the same.

This first switched-mode power supply (3aa) and first primer embedded system (3b) are ideally implemented on a double-sided PCB with surface mount encapsulates (SMD), all this to reduce the size and make its mount in the trolley can be located in the attachment boxes between trolleys.

The coin introduction detector (3e) comprises a limit switch operated by the own introduction of the coin, not shown, while the coin lock (3f) comprises a magnetic piston (3fa) energized by a relay (3fc) commanded by the first embedded system (3b), and capacitors (3fb) for supplying supplementary power to the magnetic piston (3fa). The magnetic piston (3fa) retains the coin until the first embedded system (3b) gives the activation order of the same to release the coin.

The trolley parking bay unit (4) comprises a second power supply (4a), a second embedded system (4b) with a clock (4d), a second wireless module (4c), preferably RF with two unidirectional links, emitter (4ca) and receiver (4cb), a first database (4e) for storing movements—ideally based on RAM memory—and a first interface (4f) usable to dump the data stored in the first database (4e), serving any type of connection and ideally a local network connection.

The second power supply (4a) comprises to second switched-mode power supply (4aa) powered by a second lithium ion or lithium polymer rechargeable battery (4ab) associated with a second photovoltaic unit (4ac), such that the photovoltaic unit (4ac) cooperates in recharging of the rechargeable battery (4ab). Also, the second power supply can be supplied from mains due to its fixed location.

The trolley parking bay unit (4) functions as data management unit, storing a list of all the trolleys parked at any time, as well as their entry and exit time. In addition, the order of coin release is only emitted if the trolley is in its place.

The communication between the wireless modules of the parking bay unit (4) and ID terminals (3) of each trolley (2) parked in the parking allows recording stays and entry and exit schedules. All the data stored in this first database (4e) can be dumped directly to a computer through the first interface (4f).

By its part, each unit (5) for detecting the passage of the trolley through the checkout—one per each cash register—comprises a third power supply (5a), a third embedded system (5b), a third wireless module (5c), preferably RF, a IR receiver (5d) for reception of the signal emitted by the IR emitters (3d) of them trucks (2), an invoice receipt connection (5g) with the cash register (21), a second database (5e) for storing checkouts—ideally based on RAM memory—and a second interface (5f), preferably of the type of local network, to dump the data stored in the second database (5e). In this case, the third wireless module (5c) is permanently emitting a short range signal, so it only reaches to trolley that checkout (50). The information sent indicates to the ID terminal (3) of the trolley (2) that it is checking-out. At that time the first embedded system (3b) of the ID terminal (3) will manage a routine that will include the emission of its ID and how much data is able to be stored through its IR emitter or emitters (3d), which will be read by the IR receiver (5d) of the unit (5) for detecting the passage of the trolley through the checkout, which will record the movement in the second database (5e) as well as information of the invoice obtained through the invoice receipt connection (5g). The ID terminal (3) can have more than one IR emitter (3d), one by each side, e.g., in places where the approximation to cash registers can be made by both sides, in order to be able to dump the information regardless of whether the cash register is located to the right side or to the left side of the trolley (2).

If the user has registered the items chosen by the barcode reader (3h) of the ID terminal (3) in his/her trolley (2), an option exists at some stores to make an self-reading of purchases and take less time in the checkout, the first embedded system (3b) of the ID terminal (3) will include this information in that transmitted to the IR receiver (5d). This feature is also useful to know which products the customer takes and, above all, which products he/she leaves, as well as to know the sum of the monetary amounts of the products in the trolley. In addition, distributing checking-out units (5) inside the commercial store before the actual cash registers, for example in the columns of the malls, where there are article barcode readers, data dumpings can be made in the same, retaining this information until checkout, to check what it is registered in cash register and what it is not registered, and check against the previously registered information.

All data stored in this second database (5e), of each cash register, can be dumped directly to a computer via the second interface (5f).

Also, the unit (5) for detecting the passage of the trolley through the checkout may comprise a connection (5h) to a closed-circuit television (CCTV) image-gathering system (20).

The location-finding system (6) comprises a plurality of beacons (60), each of them comprising a fourth power supply (6a), a fourth embedded system (6b), a fourth wireless module (6c), preferably RF, and a third interface (6f). The fourth wireless module (6c) of each beacon (60) will enable, when linked to the wireless module (3c) of the ID terminal (3) of each trolley (2), detecting the specific location of the trolley (2) dividing the commercial store into study areas, each of them controlled by a beacon (60). A change of area involves detecting the change of beacon (60) by the trolley ID terminal (3), and the record of the corresponding data, in its first memory (3ba), that can be dumped through the first wireless module (3c). It is therefore of a register by areas, not by coordinates. Also, the location-finding system may be implemented by any coordinate location-finding system, detailing here only a constitution very preferential for this embodiment of the invention.

The fourth power supply (6a) ideally comprises a fourth switched-mode power supply (6aa) and may be supplied from a fourth lithium ion or polymer lithium rechargeable battery (6ab) associated with a third photovoltaic unit (6ac), or from mains (6ad) given its fixed location.

In order to improve the benefits and costs of the system, it is envisioned that the programming of the ID of trolleys and/or beacons (60) is not carried out in hardware, that would imply realization in factory, but is preferably programmable in situ. For this reason, the invention also comprises one or more electronic programmers (7) of the ID terminals (3) of the trolleys (2), comprising a fourth interface (7a)—which usually includes a keyboard (7aa) and a screen (lab) for entering manual data, a third battery (7b), a fifth ideally in switched-mode, power supply (7e), a fifth wireless module (7c) and a fifth embedded system (7d). The communication with the ID terminals (3) of the trolleys (2) and/or beacons (60) is carried out through their respective wireless modules (3c, 6c, 7c). The data to be entered into the ID terminals (3) will be at least the individual identification; in the beacons (60) will be at least individual identification, date and time.

The operation of the system comprises a method that is part of the invention, since it produces technical effects, such as the release of coins, control of trolley passage throughout the commercial store, taking pictures, etc. that are part of the solution to technical problems raised. This method comprises:

a method for combined control of trolley output implemented in the ID terminal (3) and the parking bay unit (4), comprising the following steps:
detecting introduction of coins through the coin introduction detector (3e)
emitting, by the first wireless module (3c), the trolley ID for storing in the first database (4e) of the trolley parking bay unit (4),
receiving the trolley ID emitted by the first wireless module (3c) in the trolley parking bay unit (4),
recording the event and its time in the first database (4e) and memory of the ID terminal (3),
   a method for locating the trolley demarcation, comprising the following steps:
continuously emitting a beacon identifier, time and date through the fourth wireless module (6c) of each beacon (60),
reading the beacon identifier, time and date through the first wireless module (3c) of the ID terminal (3) of each trolley (2),
recording in the memory (3ba) of the ID terminal (3) of trolley (2) the beacon identifier, time and date
   a method for combined control of passage of the trolley through the checkout implemented in the ID terminal (3) and the unit (5) for detecting the passage of the trolley through the checkout, comprising the following steps:
continuously emitting an activation order from the trolley IR emitter (3d) through the third wireless module (5c) of the unit (5) for detecting the passage of the trolley through the checkout,
reading the activation order from the IR emitter through the first wireless module (3c) of the ID terminal (3) of each trolley (2)
emitting the ID and remaining data stored in the memory (3ba) of the ID terminal (3) (trolley removal schedule, route or areas visited with schedule, products registered by the barcode reader), through the trolley IR emitter (3d),
reading the invoice data through the invoice receipt connection (5g) with the cash register (21),
recording the ID, trolley data and invoice data in the second database (5e)

In addition, this method may implement a step of gathering CCTV images (20), if available.

a method for combined control of trolley input implemented in the ID terminal (3) and the trolley parking bay unit (4), comprising the following steps:
detecting the introduction of the key through the key detector (3g),
emitting the input record request through the first wireless module (3c) of the ID terminal (3) of trolley (2)
reading the trolley input record request through the second wireless module (4c) of the trolley parking bay unit (4),
recording the request in the first database (4e),
emitting order acceptance through the second wireless module (4c) of the trolley parking bay unit (4),
receiving acceptance from the trolley parking bay unit (4) through the first wireless module (3c) of the ID terminal (3) of trolley (2)
activating the coin lock (3f),

Despite the above, and since the description made only corresponds to preferred embodiments of the invention, it is understood that within its essentiality, multiple detail variations may be made, also protected, which may affect the shape, size, or manufacturing materials of the whole or its parts, without involving any alteration of the invention as a whole, limited only by the claims provided below.

1. A system (1) for controlling and managing shopping trolleys (2), comprising a ID terminal (3) for each said trolley (2) to be controlled, said terminal being equipped with means for communicating with at least one trolley parking bay unit (4), at least one location-finding system (6), and at least one unit (5) for detecting passage of the trolley through a checkout.

2. A system (1) for controlling and managing shopping trolleys (2) according to claim 1 wherein the ID terminal (3) comprises a first power supply (3a), a first embedded system (3b) with memory (3ba) for storing data and ID programming, a first wireless module (3c), at least one IR emitter (3d), a coin introduction detector (3e), a coin lock (3f) and a key detector (3g).

3. A system (1) for controlling and managing shopping trolleys (2) according to claim 2 wherein the ID terminal (3) further comprises a barcode reader (3h).

4. A system (1) for controlling and managing shopping trolleys (2) according to claim 3 characterised in that the first power supply (3a) comprises a first switched-mode power supply (3aa) powered by a first rechargeable battery (3ab) and a first photovoltaic unit (3ac).

5. A system (1) for controlling and managing shopping trolleys (2) according to claim 4 wherein the first switched-mode power supply (3aa) and the first embedded system (3b) are implemented in a PCB board.

6. A system (1) for controlling and managing shopping trolleys (2) according to claim 5 wherein the coin introduction detector (3e) comprises a limit switch.

7. A system (1) for controlling and managing shopping trolleys (2) according to claim 6 wherein the coin lock (3f) comprises a magnetic piston (3fa) energised by a relay (3fc) commanded and controlled by the first embedded system (3b), and by capacitors (3fb) for supplying supplementary power to the magnetic piston (3fa).

8. A system (1) for controlling and managing shopping trolleys (2) according to claim 7, wherein the trolley parking bay unit (4) comprises a second power supply (4a), a second embedded system (4b) with a clock (4d), a second wireless module (4c), a first database (4e) for storing movements and a first interface (4f) for dumping data stored in the first database (4e).

9. A system (1) for controlling and managing shopping trolleys (2) according to claim 8, wherein the second power supply (4a) comprises a second switched-mode power supply (4aa) powered by a second rechargeable battery (4ab) associated with a second photovoltaic unit (4ac).

10. A system (1) for controlling and managing shopping trolleys (2) according to claim 9, wherein the unit (5) for detecting the passage of the trolley through the checkout comprises a third power supply (5a), a third embedded system (5b), a third wireless module (5c), an IR receiver (5d) for reception of a signal emitted by the IR emitters (3d) of the trolleys (2), an invoice receipt connection (5g) with a cash register (21), a second database (5e) for storing checkouts, and a second interface (5f) for dumping data stored in the second database (5e).

11. A system (1) for controlling and managing shopping trolleys (2) according to claim 10, wherein the unit (5) for detecting the passage of the trolley through the checkout further comprises a connection (5h) to a CCTV image-gathering system (20).

12. A system (1) for controlling and managing shopping trolleys (2) according to claim 11, wherein the location-finding system (6) comprises a plurality of beacons (60), each of the beacons comprising a fourth power supply (6a), a fourth embedded system (6b), a fourth wireless module (6c), and a third interface (6f).

13. A system (1) for controlling and managing shopping trolleys (2) according to claim 12, wherein the fourth power supply (6a) comprises a fourth switched-mode power supply (6aa) powered from a fourth rechargeable battery (6ab), a third photovoltaic unit (6ac) and/or from mains (6ad).

14. A system (1) for controlling and managing shopping trolleys (2) according to claim 13, further comprising an electronic programmer (7) of the ID terminals (3) and/or the beacons (60) of trolleys (2).

15. A system (1) for controlling and managing shopping trolleys (2) according to claim 14, wherein the programmer (7) comprises a fourth interface (7a) for entering manual data, a third battery (7b), a fifth wireless module (7c), a fifth power supply (7e) to adjust the voltage, and a fifth embedded system (7d).

16. A method for controlling and managing shopping trolleys (2), wherein an ID terminal (3) and a trolley parking bay unit (4) implement combined control of trolley output, comprising the following steps:
detecting introduction of coins through a coin introduction detector (3e),
emitting a trolley ID via a first wireless module (3c),
receiving the trolley ID emitted by the first wireless module (3c) in the trolley parking bay unit (4),
recording an event associated with the trolley and its time-of-day in a first database (4e) and memory of the ID terminal (3);
wherein the ID terminal (3) and a unit (5) for detecting passage of the trolley through a checkout implement the following steps for combined control of passage of the trolley through the checkout:
continuously emitting an activation order of a trolley IR emitter (3d) through a wireless emitter (5c),
reading an activation order from the IR emitter through the first wireless module (3c) of the ID terminal (3) of the trolley (2),
emitting the ID and remaining data stored in a memory (3ba) of the ID terminal (3) through the trolley IR emitter (3d),
reading invoice data through an invoice receipt connection (5g) with a cash register (21),
recording the ID, trolley data and invoice data in a second database (5e);
wherein the ID terminal (3) and a location-finding system (6) implement the following steps for locating trolley demarcation:
continuously emitting a beacon identifier, time and date through a fourth wireless module (6c) of each of a plurality of beacons (60),
reading the beacon identifier, time and date through the first wireless module (3c) of the ID terminal (3) of each said trolley (2),
recording the beacon identifier, time and date in the memory (3ba) of the ID terminal (3) of said trolley (2);
and wherein the ID terminal (3) and the trolley parking bay unit (4) implement the following steps for combined control of trolley input:
detecting introduction of a key through a key detector (3g),
emitting an input record request through the first wireless module (3c) of the ID terminal (3) of trolley (2),
reading the trolley input record request through a second wireless module (4c) of the trolley parking bay unit (4),
recording the request in the first database (4e),
emitting order acceptance through the second wireless module (4c) of the trolley parking bay unit (4),
receiving acceptance from the trolley parking bay unit (4) through the first wireless module (3c) of the ID terminal (3) of trolley (2), and
activating a coin lock (3f).

17. The method for controlling and managing shopping trolleys (2) according to claim 16, wherein the steps for combined control of passage of the trolley through the checkout comprise a further step of gathering CCTV images (20).
